(19) United States
(12) Patent Application Publication
(10) Pub. No.: US 2022/0398336 A1
(43) Pub. Date: Dec. 15, 2022

(54) MECHANISMS FOR SECURE USER INPUT

(71) Applicant: Citrix Systems, Inc., Fort Lauderdale, FL (US)

(72) Inventors: Hao Wu, Nanjing (CN); Yinyan Huang, Nanjing (CN); Cungang Lin, Nanjing (CN)

(21) Appl. No.: 17/486,146

(22) Filed: Sep. 27, 2021

Related U.S. Application Data
(63) Continuation of application No. PCT/CN2021/100158, filed on Jun. 15, 2021.

(51) Int. Cl. G06F 21/62; G06F 3/01; G06F 3/16; G06F 3/0488; G06F 3/0484

(52) U.S. Cl. CPC G06F 21/6218; G06F 3/016; G06F 3/165; G06F 3/04886; G06F 3/0484; G06F 3/0482

(57) ABSTRACT

Methods, apparatuses, and systems for secure data input mechanisms are described herein. An example method comprises monitoring a user interface presented on a display of a mobile device, identifying an input field of the application shown within the display, and adjusting operation of the mobile device in response to entry of data within the input field, the adjusting operation occurring via an input method, the input method changing at least one characteristic of the mobile device indicative of entry of data with use of the mobile device, so as to prevent acquisition of the data by a malicious application installed on the mobile device.

### CROSS-REFERENCE TO RELATED APPLICATION

This application is a continuation of International Application No. PCT/CN2021/100158, filed on Jun. 15, 2021.

### FIELD

Aspects described herein generally relate to computer networking, and hardware and software related thereto. More specifically, one or more aspects describe herein provide techniques for preventing loss of data to malicious applications.

### BACKGROUND

Hardware sensors such as gyroscopes, magnetometers, and accelerometers are ubiquitous in smartphones, tablets, and many other devices. These sensors may provide motion data useful for a number of applications to improve the functionality of mobile devices. When a user interacts with a soft keyboard displayed within the user interface of a mobile device, the tap events may cause the motion of the device to change, which is subsequently recorded as motion data by said sensors.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

As mentioned above, hardware sensors of computing devices often times record interactions between a user and the device. Third-party apps installed on computing devices can generally access this raw motion data without any security permission requirements. Malicious applications installed on the mobile device may exploit or otherwise use this raw motion data to infer or identify sensitive information such as, for example, password, date of birth, payment, and social security data, which poses a significant threat to user privacy.

Aspects described herein relate to methods, systems and techniques that may monitor a user interface on a mobile device and adjusting operation of the mobile device in response to entry of data within the input field. The adjustment may change at least one characteristic of the mobile device corresponding to the entry of data and indicative of use of the mobile device so as to prevent acquisition of the data by a malicious application installed on the mobile device.

An example method may comprise monitoring a user interface presented on a display of a mobile device, wherein the user interface enables access to an application, and wherein the display receives touch input for entry of data into the application, identifying, based on content of the user interface, an input field of the application shown within the display, and adjusting operation of the mobile device in response to entry of data within the input field, the adjusting operation occurring via an input method which changes at least one characteristic of the mobile device indicative of entry of data with use of the mobile device so as to prevent acquisition of the data entered into the application by a malicious application installed on the mobile device.

An example apparatus may comprise a mobile device comprising one or more processors and a memory, wherein the memory stores instructions that, when executed by the one or more processors, cause the mobile device to monitor a user interface presented on a display of a mobile device, wherein the user interface enables access to an application, and wherein the display receives touch input for entry of data into the application, identify, based on content of the user interface, an input field of the application shown within the display, and adjust operation of the mobile device via an input method in response to entry of data within the input field, the input method changing at least one characteristic of the mobile device indicative of entry of data with use of the mobile device, so as to prevent acquisition of the data by a malicious application installed on the mobile device.

An example system may comprise a mobile device comprising one or more processors and a memory, wherein the memory stores instructions that, when executed by the one or more processors, cause the mobile device to monitor a user interface presented on a display of the mobile device, the user interface enabling access to an application, and the display configured to receive touch input for entry of data into the application, identify, based on content of the user interface, an input field of the application shown within the display, and adjust operation of the mobile device via an input method in response to entry of data within the input field, the input method configured to change at least one characteristic of the mobile device indicative of entry of data with use of the mobile device, so as to prevent acquisition of the data by a malicious application installed on the mobile device.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative cloud-based system architecture that may be used in accordance with one or more illustrative aspects described herein.

FIG. 4A depicts a block diagram of an example system in which resource management services may manage and streamline access by clients to resource feeds (via one or more gateway services) and/or software-as-a-service (SaaS) applications.

FIG. 4B depicts a block diagram showing an example implementation of the system shown in FIG. 4A in which various resource management services as well as a gateway service are located within a cloud computing environment.

FIG. 4C depicts a block diagram similar to that shown in FIG. 4B but in which the available resources are represented by a single box labeled “systems of record,” and further in which several different services are included among the resource management services.

FIG. 5 depicts how a display screen may appear when an intelligent activity feed feature of a multi-resource management system, such as that shown in FIG. 4C, is employed.

FIG. 6 depicts an illustrative mobile device that may be used in accordance with one or more illustrative aspects described herein.

FIG. 7 depicts an illustrative system flow that may be used in accordance with one or more illustrative aspects described herein.

FIG. 8 depicts an illustrative flow diagram of a method that may be used in accordance with one or more illustrative aspects described herein.

FIG. 9 depicts another illustrative flow diagram of a method that may be used in accordance with one or more illustrative aspects described herein.

FIG. 10 depicts another illustrative flow diagram of a method that may be used in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein relate to methods of adjusting, for example, at least one characteristic of the mobile device indicative of tap events within a display of a mobile device so as to prevent data loss to a malicious application installed on the mobile device. The mobile device may detect user input into an input field. The mobile device may disable, for example, a motion sensor component of the mobile device based on determining that the user input field corresponds to a type of user input field. As a result, users may securely input sensitive information into an input field and may prevent a malicious background application from inferring keystrokes based on motion data generated by user interaction with the user interface of the mobile device.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Computing Architecture

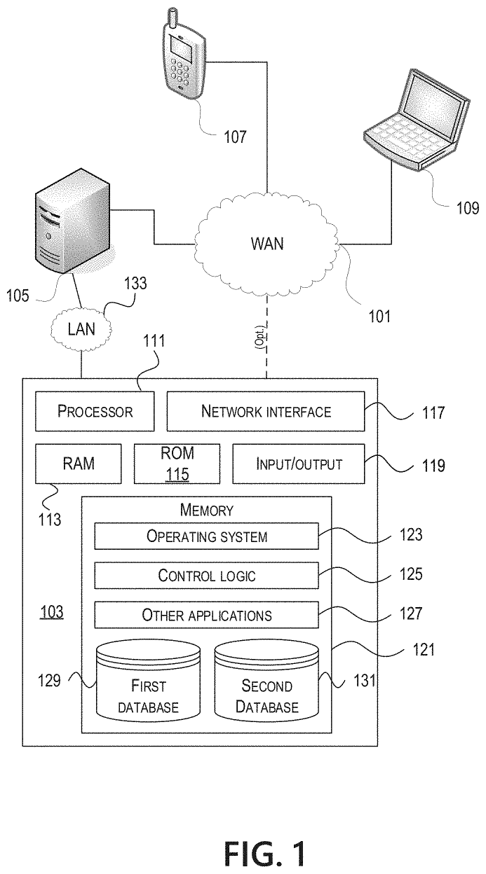

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

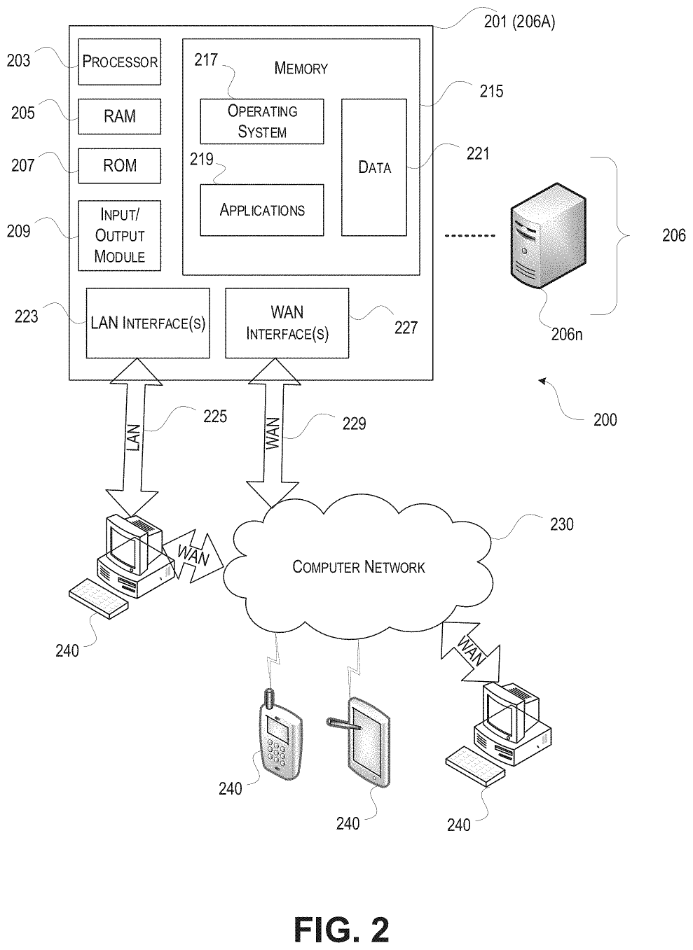

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

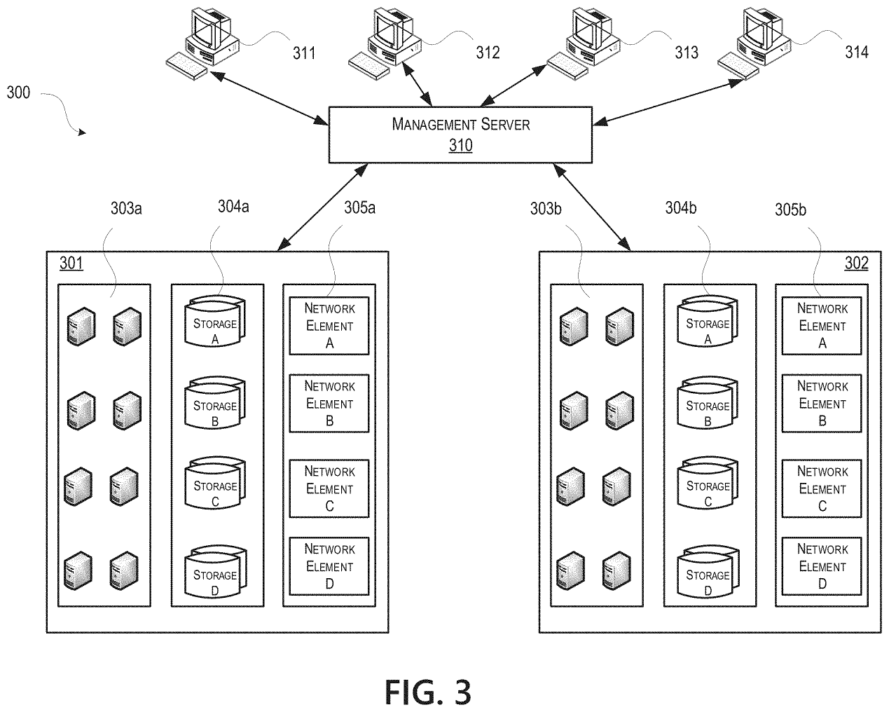

With further reference to FIG. 3, some aspects described herein may be implemented in a cloud-based environment. FIG. 3 illustrates an example of a cloud computing environment (or cloud system) 300. As seen in FIG. 3, client computers 311-314 may communicate with a cloud management server 310 to access the computing resources (e.g., host servers 303a-303b (generally referred herein as “host servers 303”), storage resources 304a-304b (generally referred herein as “storage resources 304”), and network elements 305a-305b (generally referred herein as “network resources 305”)) of the cloud system.

Management server 310 may be implemented on one or more physical servers. The management server 310 may run, for example, Citrix Cloud by Citrix Systems, Inc. of Ft. Lauderdale, Fla., or OPENSTACK, among others. Management server 310 may manage various computing resources, including cloud hardware and software resources, for example, host computers 303, data storage devices 304, and networking devices 305. The cloud hardware and software resources may include private and/or public components. For example, a cloud may be configured as a private cloud to be used by one or more particular customers or client computers 311-314 and/or over a private network. In other embodiments, public clouds or hybrid public-private clouds may be used by other customers over an open or hybrid networks.

Management server 310 may be configured to provide user interfaces through which cloud operators and cloud customers may interact with the cloud system 300. For example, the management server 310 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 310 also may include a set of APIs and/or one or more customer console applications with user interfaces configured to receive cloud computing requests from end users via client computers 311-314, for example, requests to create, modify, or destroy virtual machines within the cloud. Client computers 311-314 may connect to management server 310 via the Internet or some other communication network, and may request access to one or more of the computing resources managed by management server 310. In response to client requests, the management server 310 may include a resource manager configured to select and provision physical resources in the hardware layer of the cloud system based on the client requests. For example, the management server 310 and additional components of the cloud system may be configured to provision, create, and manage virtual machines and their operating environments (e.g., hypervisors, storage resources, services offered by the network elements, etc.) for customers at client computers 311-314, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 311-314 may be related, for example, to different client computers creating virtual machines on behalf of the same end user, or different users affiliated with the same company or organization. In other examples, certain clients 311-314 may be unrelated, such as users affiliated with different companies or organizations. For unrelated clients, information on the virtual machines or storage of any one user may be hidden from other users.

Referring now to the physical hardware layer of a cloud computing environment, availability zones 301-302 (or zones) may refer to a collocated set of physical computing resources. Zones may be geographically separated from other zones in the overall cloud of computing resources. For example, zone 301 may be a first cloud datacenter located in California, and zone 302 may be a second cloud datacenter located in Florida. Management server 410 may be located at one of the availability zones, or at a separate location. Each zone may include an internal network that interfaces with devices that are outside of the zone, such as the management server 310, through a gateway. End users of the cloud (e.g., clients 311-314) might or might not be aware of the distinctions between zones. For example, an end user may request the creation of a virtual machine having a specified amount of memory, processing power, and network capabilities. The management server 310 may respond to the user's request and may allocate the resources to create the virtual machine without the user knowing whether the virtual machine was created using resources from zone 301 or zone 302. In other examples, the cloud system may allow end users to request that virtual machines (or other cloud resources) are allocated in a specific zone or on specific resources 303-305 within a zone.

In this example, each zone 301-302 may include an arrangement of various physical hardware components (or computing resources) 303-305, for example, physical hosting resources (or processing resources), physical network resources, physical storage resources, switches, and additional hardware resources that may be used to provide cloud computing services to customers. The physical hosting resources in a cloud zone 301-302 may include one or more computer servers 303. The physical network resources in a cloud zone 301 or 302 may include one or more network elements 305 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 301-302 may include storage disks (e.g., solid state drives (SSDs), magnetic hard disks, etc.) and other storage devices.

The example cloud computing environment shown in FIG. 3 also may include a virtualization layer (e.g., as shown in FIGS. 1-2) with additional hardware and/or software resources configured to create and manage virtual machines and provide other services to customers using the physical resources in the cloud. The virtualization layer may include hypervisors, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 303 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Resource Management System

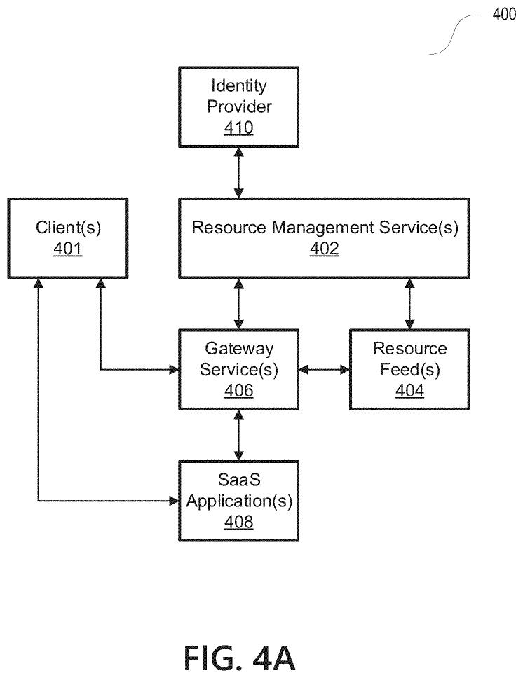

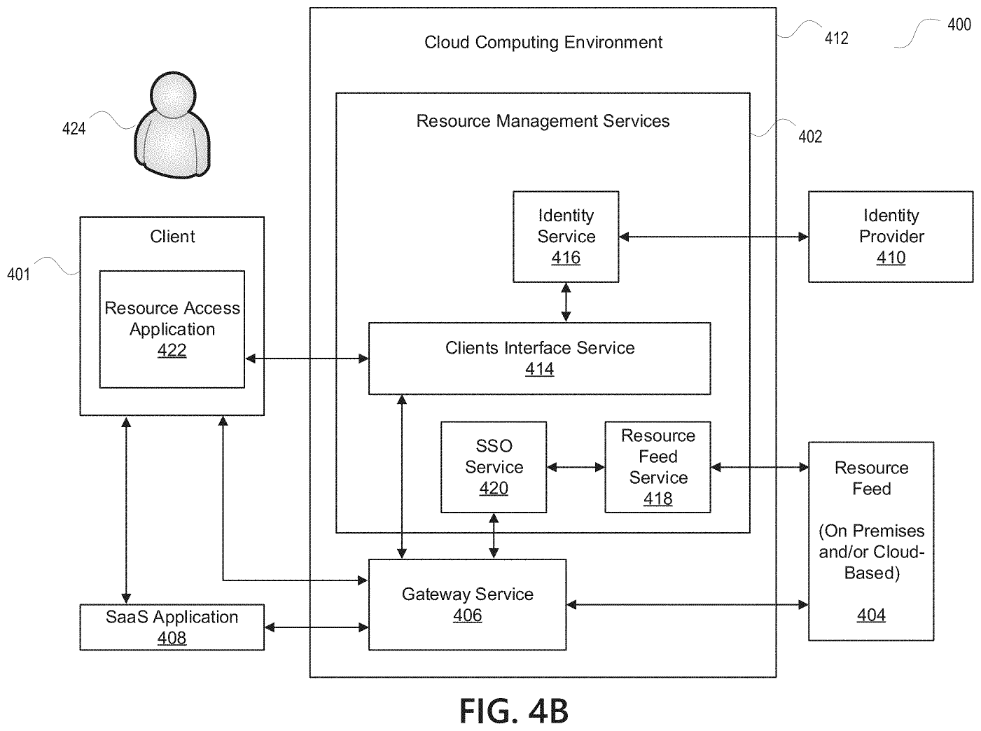

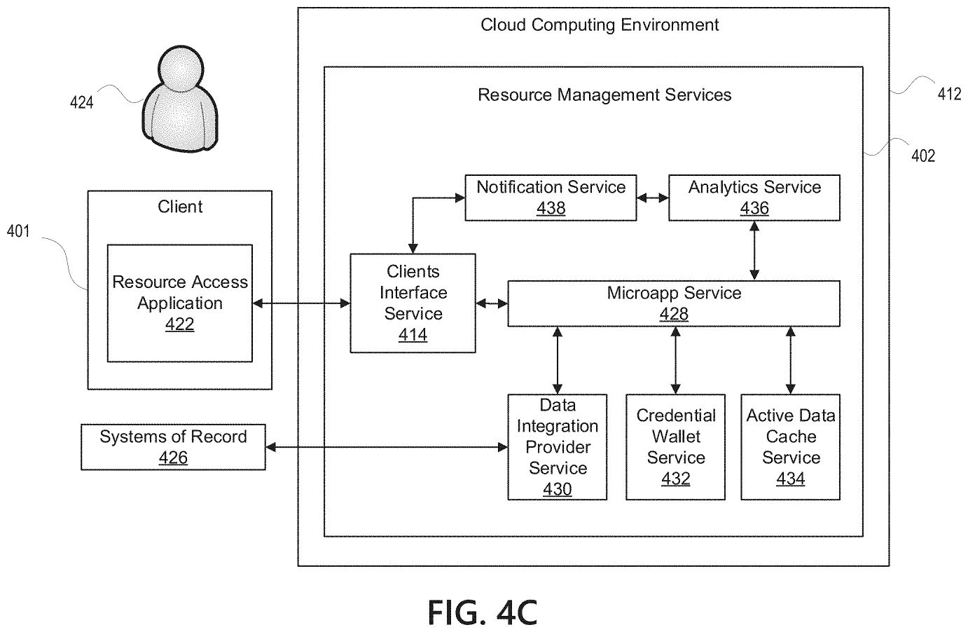

FIG. 4A is a block diagram of an example multi-resource access system 400 in which one or more resource management services 402 may manage and streamline access by one or more clients 401 to one or more resource feeds 404 (via one or more gateway services 406) and/or one or more software-as-a-service (SaaS) applications 408. In particular, the resource management service(s) 402 may employ an identity provider 410 to authenticate the identity of a user of a client 401 and, following authentication, identify one of more resources the user is authorized to access. In response to the user selecting one of the identified resources, the resource management service(s) 402 may send appropriate access credentials to the requesting client 401, and the client 401 may then use those credentials to access the selected resource. For the resource feed(s) 404, the client 401 may use the supplied credentials to access the selected resource via a gateway service 406. For the SaaS application(s) 408, the client 401 may use the credentials to access the selected application directly.

The client(s) 401 may be any type of computing devices capable of accessing the resource feed(s) 404 and/or the SaaS application(s) 408, and may, for example, include a variety of desktop or laptop computers, smartphones, tablets, etc. The resource feed(s) 404 may include any of numerous resource types and may be provided from any of numerous locations. In some embodiments, for example, the resource feed(s) 404 may include one or more systems or services for providing virtual applications and/or desktops to the client(s) 401, one or more file repositories and/or file sharing systems, one or more secure browser services, one or more access control services for the SaaS applications 408, one or more management services for local applications on the client(s) 401, one or more internet enabled devices or sensors, etc. The resource management service(s) 402, the resource feed(s) 404, the gateway service(s) 406, the SaaS application(s) 408, and the identity provider 410 may be located within an on-premises data center of an organization for which the multi-resource access system 400 is deployed, within one or more cloud computing environments, or elsewhere.

FIG. 4B is a block diagram showing an example implementation of the multi-resource access system 400 shown in FIG. 4A in which various resource management services 402 as well as a gateway service 406 are located within a cloud computing environment 412. The cloud computing environment may, for example, include Microsoft Azure Cloud, Amazon Web Services, Google Cloud, or IBM Cloud. It should be appreciated, however, that in other implementations, one or more (or all) of the components of the resource management services 402 and/or the gateway service 406 may alternatively be located outside the cloud computing environment 412, such as within a data center hosted by an organization.

For any of the illustrated components (other than the client 401) that are not based within the cloud computing environment 412, cloud connectors (not shown in FIG. 4B) may be used to interface those components with the cloud computing environment 412. Such cloud connectors may, for example, run on Windows Server instances and/or Linux Server instances hosted in resource locations and may create a reverse proxy to route traffic between those resource locations and the cloud computing environment 412. In the illustrated example, the cloud-based resource management services 402 include a client interface service 414, an identity service 416, a resource feed service 418, and a single sign-on service 420. As shown, in some embodiments, the client 401 may use a resource access application 422 to communicate with the client interface service 414 as well as to present a user interface on the client 401 that a user 424 can operate to access the resource feed(s) 404 and/or the SaaS application(s) 408. The resource access application 422 may either be installed on the client 401, or may be executed by the client interface service 414 (or elsewhere in the multi-resource access system 400) and accessed using a web browser (not shown in FIG. 4B) on the client 401.

As explained in more detail below, in some embodiments, the resource access application 422 and associated components may provide the user 424 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 422 is launched or otherwise accessed by the user 424, the client interface service 414 may send a sign-on request to the identity service 416. In some embodiments, the identity provider 410 may be located on the premises of the organization for which the multi-resource access system 400 is deployed. The identity provider 410 may, for example, correspond to an on-premises Windows Active Directory. In such embodiments, the identity provider 410 may be connected to the cloud-based identity service 416 using a cloud connector (not shown in FIG. 4B), as described above. Upon receiving a sign-on request, the identity service 416 may cause the resource access application 422 (via the client interface service 414) to prompt the user 424 for the user's authentication credentials (e.g., user-name and password). Upon receiving the user's authentication credentials, the client interface service 414 may pass the credentials along to the identity service 416, and the identity service 416 may, in turn, forward them to the identity provider 410 for authentication, for example, by comparing them against an Active Directory domain. Once the identity service 416 receives confirmation from the identity provider 410 that the user's identity has been properly authenticated, the client interface service 414 may send a request to the resource feed service 418 for a list of subscribed resources for the user 424.

In other embodiments (not illustrated in FIG. 4B), the identity provider 410 may be a cloud-based identity service, such as a Microsoft Azure Active Directory. In such embodiments, upon receiving a sign-on request from the client interface service 414, the identity service 416 may, via the client interface service 414, cause the client 401 to be redirected to the cloud-based identity service to complete an authentication process. The cloud-based identity service may then cause the client 401 to prompt the user 424 to enter the user's authentication credentials. Upon determining the user's identity has been properly authenticated, the cloud-based identity service may send a message to the resource access application 422 indicating the authentication attempt was successful, and the resource access application 422 may then inform the client interface service 414 of the successfully authentication. Once the identity service 416 receives confirmation from the client interface service 414 that the user's identity has been properly authenticated, the client interface service 414 may send a request to the resource feed service 418 for a list of subscribed resources for the user 424.

The resource feed service 418 may request identity tokens for configured resources from the single sign-on service 420. The resource feed service 418 may then pass the feed-specific identity tokens it receives to the points of authentication for the respective resource feeds 404. The resource feeds 404 may then respond with lists of resources configured for the respective identities. The resource feed service 418 may then aggregate all items from the different feeds and forward them to the client interface service 414, which may cause the resource access application 422 to present a list of available resources on a user interface of the client 401. The list of available resources may, for example, be presented on the user interface of the client 401 as a set of selectable icons or other elements corresponding to accessible resources. The resources so identified may, for example, include one or more virtual applications and/or desktops (e.g., Citrix Virtual Apps and Desktops™ VMware Horizon, Microsoft RDS, etc.), one or more file repositories and/or file sharing systems (e.g., Sharefile®, one or more secure browsers, one or more internet enabled devices or sensors, one or more local applications installed on the client 401, and/or one or more SaaS applications 408 to which the user 424 has subscribed. The lists of local applications and the SaaS applications 408 may, for example, be supplied by resource feeds 404 for respective services that manage which such applications are to be made available to the user 424 via the resource access application 422. Examples of SaaS applications 408 that may be managed and accessed as described herein include Microsoft Office 365 applications, SAP SaaS applications, Workday applications, etc.

For resources other than local applications and the SaaS application(s) 408, upon the user 424 selecting one of the listed available resources, the resource access application 422 may cause the client interface service 414 to forward a request for the specified resource to the resource feed service 418. In response to receiving such a request, the resource feed service 418 may request an identity token for the corresponding feed from the single sign-on service 420. The resource feed service 418 may then pass the identity token received from the single sign-on service 420 to the client interface service 414 where a launch ticket for the resource may be generated and sent to the resource access application 422. Upon receiving the launch ticket, the resource access application 422 may initiate a secure session to the gateway service 406 and present the launch ticket. When the gateway service 406 is presented with the launch ticket, it may initiate a secure session to the appropriate resource feed and present the identity token to that feed to seamlessly authenticate the user 424. Once the session initializes, the client 401 may proceed to access the selected resource.

When the user 424 selects a local application, the resource access application 422 may cause the selected local application to launch on the client 401. When the user 424 selects a SaaS application 408, the resource access application 422 may cause the client interface service 414 to request a one-time uniform resource locator (URL) from the gateway service 406 as well a preferred browser for use in accessing the SaaS application 408. After the gateway service 406 returns the one-time URL and identifies the preferred browser, the client interface service 414 may pass that information along to the resource access application 422. The client 401 may then launch the identified browser and initiate a connection to the gateway service 406. The gateway service 406 may then request an assertion from the single sign-on service 420. Upon receiving the assertion, the gateway service 406 may cause the identified browser on the client 401 to be redirected to the logon page for identified SaaS application 408 and present the assertion. The SaaS may then contact the gateway service 406 to validate the assertion and authenticate the user 424. Once the user has been authenticated, communication may occur directly between the identified browser and the selected SaaS application 408, thus allowing the user 424 to use the client 401 to access the selected SaaS application 408.

In some embodiments, the preferred browser identified by the gateway service 406 may be a specialized browser embedded in the resource access application 422 (when the resource access application 422 is installed on the client 401) or provided by one of the resource feeds 404 (when the resource access application 422 is located remotely), e.g., via a secure browser service. In such embodiments, the SaaS applications 408 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 401 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 404) for assessment of its security risk by a web filtering service. For approved URLs, the specialized browser may be permitted to access the link. For suspicious links, however, the web filtering service may have the client interface service 414 send the link to a secure browser service, which may start a new virtual browser session with the client 401, and thus allow the user to access the potentially harmful linked content in a safe environment.

In some embodiments, in addition to or in lieu of providing the user 424 with a list of resources that are available to be accessed individually, as described above, the user 424 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 401 to notify a user 424 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 426 labeled “systems of record,” and further in which several different services are included within the resource management services block 402. As explained below, the services shown in FIG. 4C may enable the provision of a streamlined resource activity feed and/or notification process for a client 401. In the example shown, in addition to the client interface service 414 discussed above, the illustrated services include a microapp service 428, a data integration provider service 430, a credential wallet service 432, an active data cache service 434, an analytics service 436, and a notification service 438. In various embodiments, the services shown in FIG. 4C may be employed either in addition to or instead of the different services shown in FIG. 4B. Further, as noted above in connection with FIG. 4B, it should be appreciated that, in other implementations, one or more (or all) of the components of the resource management services 402 shown in FIG. 4C may alternatively be located outside the cloud computing environment 412, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 422 without having to launch the native application. The system shown in FIG. 4C may, for example, aggregate relevant notifications, tasks, and insights, and thereby give the user 424 a dynamic productivity tool. In some embodiments, the resource activity feed may be intelligently populated by utilizing machine learning and artificial intelligence (AI) algorithms. Further, in some implementations, microapps may be configured within the cloud computing environment 412, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, the systems of record 426 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 430, may, for example, support REST API, JSON, OData-JSON, and 6ML. As explained in more detail below, the data integration provider service 430 may also write back to the systems of record, for example, using OAuth2 or a service account.

In some embodiments, the microapp service 428 may be a single-tenant service responsible for creating the microapps. The microapp service 428 may send raw events, pulled from the systems of record 426, to the analytics service 436 for processing. The microapp service may, for example, periodically cause active data to be pulled from the systems of record 426.

In some embodiments, the active data cache service 434 may be single-tenant and may store all configuration information and microapp data. It may, for example, utilize a per-tenant database encryption key and per-tenant database credentials.

In some embodiments, the credential wallet service 432 may store encrypted service credentials for the systems of record 426 and user OAuth2 tokens.

In some embodiments, the data integration provider service 430 may interact with the systems of record 426 to decrypt end-user credentials and write back actions to the systems of record 426 under the identity of the end-user. The write-back actions may, for example, utilize a user's actual account to ensure all actions performed are compliant with data policies of the application or other resource being interacted with.

In some embodiments, the analytics service 436 may process the raw events received from the microapp service 428 to create targeted scored notifications and send such notifications to the notification service 438.

Finally, in some embodiments, the notification service 438 may process any notifications it receives from the analytics service 436. In some implementations, the notification service 438 may store the notifications in a database to be later served in an activity feed. In other embodiments, the notification service 438 may additionally or alternatively send the notifications out immediately to the client 401 as a push notification to the user 424.

In some embodiments, a process for synchronizing with the systems of record 426 and generating notifications may operate as follows. The microapp service 428 may retrieve encrypted service account credentials for the systems of record 426 from the credential wallet service 432 and request a sync with the data integration provider service 430. The data integration provider service 430 may then decrypt the service account credentials and use those credentials to retrieve data from the systems of record 426. The data integration provider service 430 may then stream the retrieved data to the microapp service 428. The microapp service 428 may store the received systems of record data in the active data cache service 434 and also send raw events to the analytics service 436. The analytics service 436 may create targeted scored notifications and send such notifications to the notification service 438. The notification service 438 may store the notifications in a database to be later served in an activity feed and/or may send the notifications out immediately to the client 401 as a push notification to the user 424.

In some embodiments, a process for processing a user-initiated action via a microapp may operate as follows. The client 401 may receive data from the microapp service 428 (via the client interface service 414) to render information corresponding to the microapp. The microapp service 428 may receive data from the active data cache service 434 to support that rendering. The user 424 may invoke an action from the microapp, causing the resource access application 422 to send an action request to the microapp service 428 (via the client interface service 414). The microapp service 428 may then retrieve from the credential wallet service 432 an encrypted Oauth2 token for the system of record for which the action is to be invoked, and may send the action to the data integration provider service 430 together with the encrypted OAuth2 token. The data integration provider service 430 may then decrypt the OAuth2 token and write the action to the appropriate system of record under the identity of the user 424. The data integration provider service 430 may then read back changed data from the written-to system of record and send that changed data to the microapp service 428. The microapp service 428 may then update the active data cache service 434 with the updated data and cause a message to be sent to the resource access application 422 (via the client interface service 414) notifying the user 424 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 402 may, for example, parse these requests and respond because they are integrated with multiple systems on the back-end. In some embodiments, users may be able to interact with the virtual assistant through either the resource access application 422 or directly from another resource, such as Microsoft Teams. This feature may allow employees to work efficiently, stay organized, and deliver only the specific information they're looking for.

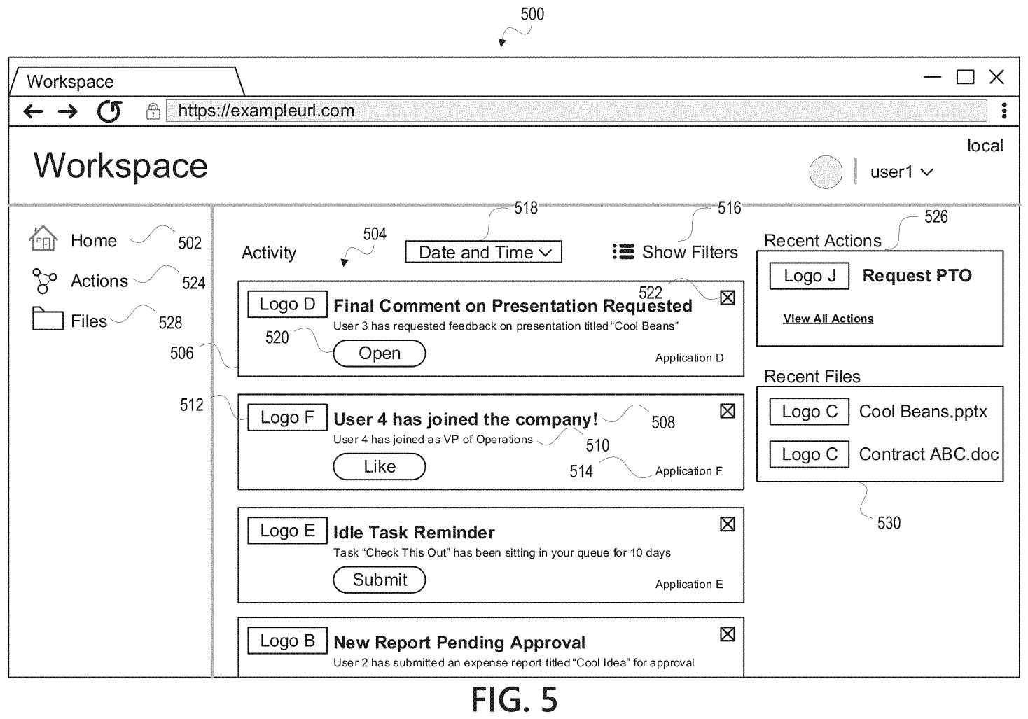

FIG. 5 shows how a display screen 500 presented by a resource access application 422 (shown in FIG. 4C) may appear when an intelligent activity feed feature is employed and a user is logged on to the system. Such a screen may be provided, for example, when the user clicks on or otherwise selects a “home” user interface element 502. As shown, an activity feed 504 may be presented on the screen 500 that includes a plurality of notifications 506 about respective events that occurred within various applications to which the user has access rights. An example implementation of a system capable of providing an activity feed 504 like that shown is described above in connection with FIG. 4C. As explained above, a user's authentication credentials may be used to gain access to various systems of record (e.g., SalesForce®, Ariba®, Concur®, RightSignature®, etc.) with which the user has accounts, and events that occur within such systems of record may be evaluated to generate notifications 506 to the user concerning actions that the user can take relating to such events. As shown in FIG. 5, in some implementations, the notifications 506 may include a title 508 and a body 510, and may also include a logo 512 and/or a name 514 of the system or record to which the notification 506 corresponds, thus helping the user understand the proper context with which to decide how best to respond to the notification 506. In some implementations, one of more filters may be used to control the types, date ranges, etc., of the notifications 506 that are presented in the activity feed 504. The filters that can be used for this purpose may be revealed, for example, by clicking on or otherwise selecting a “show filters” user interface element 516. Further, in some embodiments, a user interface element 518 may additionally or alternatively be employed to select a manner in which the notifications 506 are sorted within the activity feed. In some implementations, for example, the notifications 506 may be sorted in accordance with the “date and time” they were created (as shown for the element 518 in FIG. 5) and/or an “application” mode (not illustrated) may be selected (e.g., using the element 518) in which the notifications 506 may be sorted by application type.

When presented with the activity feed 504, the user may respond to the notifications 506 by clicking on or otherwise selecting a corresponding action element 520 (e.g., “Approve,” “Reject,” “Open,” “Like,” “Submit,” etc.), or else by dismissing the notification, e.g., by clicking on or otherwise selecting a “close” element 522. As explained in connection with FIG. 4C above, the notifications 506 and corresponding action elements 522 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 506 (e.g., in a separate, pop-up window corresponding to the microapp) by clicking on or otherwise selecting a portion of the notification 506 other than one of the user-interface elements 520, 522. In some embodiments, the user may additionally or alternatively be able to select a user interface element either within the notification 506 or within a separate window corresponding to the microapp that allows the user to launch the native application to which the notification relates and respond to the event that prompted the notification via that native application rather than via the microapp. In addition to the event-driven actions accessible via the action elements 520 in the notifications 506, a user may alternatively initiate microapp actions by selecting a desired action, e.g., via a drop-down menu accessible using an “actions” user-interface element 524 or by selecting a desired action from a list 526 of recently and/or commonly used microapp actions. As shown, the user may also access files (e.g., via a Citrix ShareFile™ platform) by selecting a desired file, e.g., via a drop-down menu accessible using the “files” user interface element 528 or by selecting a desired file from a list 530 of recently and/or commonly used files.

Although not shown in FIG. 5, it should be appreciated that, in some implementations, additional resources may also be accessed through the screen 500 by clicking on or otherwise selecting one or more other user interface elements that may be presented on the screen. For example, in some embodiments, one or more virtualized applications may be accessible (e.g., via a Citrix Virtual Apps and Desktops™ service) by clicking on or otherwise selecting an “apps” user-interface element (not shown) to reveal a list of accessible applications and/or one or more virtualized desktops may be accessed (e.g., via a Citrix Virtual Apps and Desktops® service) by clicking on or otherwise selecting a “desktops” user-interface element (not shown) to reveal a list of accessible desktops.

The activity feed shown in FIG. 5 provides significant benefits, as it allows a user to respond to application-specific events generated by disparate systems of record without needing to navigate to, launch, and interface with multiple different native applications.

Mechanisms for Secure User Input

In some examples, a malicious application may be installed on a mobile device and may be configured to acquire sensitive user input data (e.g., by inferring keystrokes) based on one or more characteristics of the mobile device indicative of the operation of the mobile device. In some examples, those characteristics may be motion data generated by various hardware sensor components of the mobile device when the user inputs text into an input field within the interface of an application accessible via the mobile device. In some examples, the application may be local, remote, virtual, or cloud-based applications. As described herein, different embodiments may be executable on the mobile device or a remote server to adjust operation of the mobile device to prevent acquisition of sensitive user input data entered into the applications accessible via the mobile device.

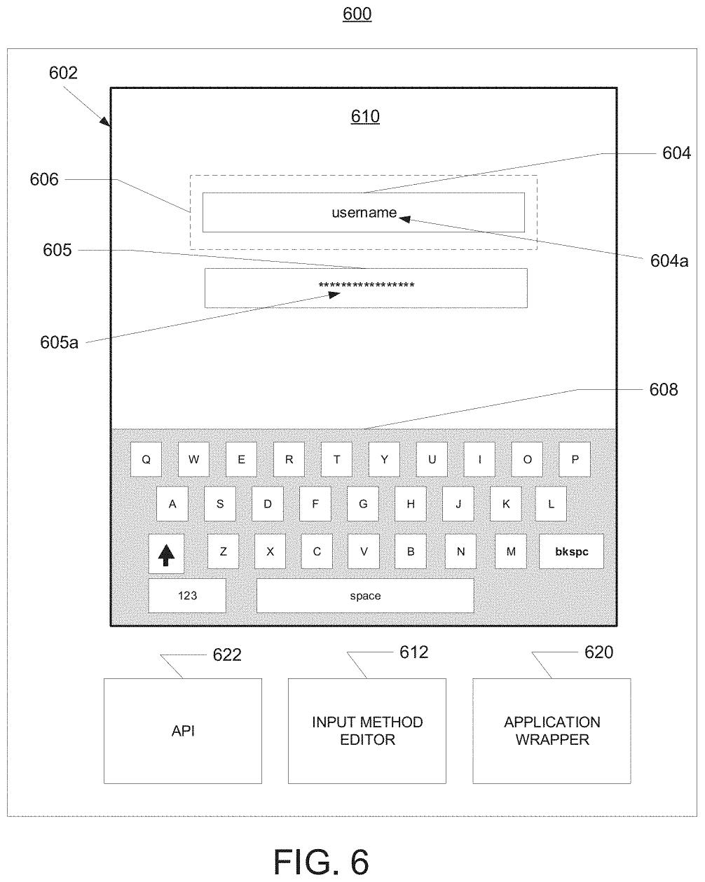

FIG. 6 depicts an illustrative mobile device 600. The mobile device 600 may be any one of the client devices 107, 109, 240 described with respect to FIGS. 1-2, the computing device 201 described with respect to FIG. 2, or the client 501 described with respect to FIG. 5. The mobile device 600 may include, for example, at least one processor and at least one memory. The mobile device may run an iOS operating system, and Android operating system, or the like.

The mobile device 600 may include at least one hardware sensor component including, but not limited to, a gyroscope, a magnetometer, an orientation sensor, a gravity sensor, a rotation vector sensor, or an accelerometer (collectively, “motion sensors”) (not shown). The mobile device may include a display 602 configured to receive touch input for entry of data. The mobile device may include an application local to the device, virtual, or cloud-based (not shown). In some examples, the application may be wrapped by an application wrapper 620 to execute in accordance with a set of one or more policy files received separate from the application, and which define one or more security parameters, features, resource restrictions, and/or other access controls that are enforced by the application wrapper 620 when that application is executing on the mobile device 600. In some examples, the policy files may include integrated policies that block or disable the motion sensors of the mobile device 600. In other examples, the policy files may include integrated policies that restrict the application from accessing data generated by the motion sensors.

The application may provide a user interface 602 that enables access to and facilitates user interaction with the application. The mobile device may include a soft (or “virtual”) keyboard 608 which may enable a user to interact with the user interface 602 and may enable a user to enter user input 604a and 605a into user input fields 604 and 605, respectively. User input 604a and 605a may be, for example, password information, social security information, data of birth information, payment information, and/or other sensitive information. The mobile device may include an input method editor (IME) 612 that interacts with the keyboard 608, the motion sensors, the processor, the memory, the API 622 of the mobile device operating system, and various other components of the mobile device 600. The IME 612 may adjust at least one characteristic of the mobile device 600 indicative of the operation of the mobile device. Such mobile device characteristics may include vibration motor operation, microphone operation, speaker operation, or motion sensor operation. The IME 612 may be configured as an application and executable on the mobile device 600. The IME 612 may be configured as the default input method editor of the mobile device 600.

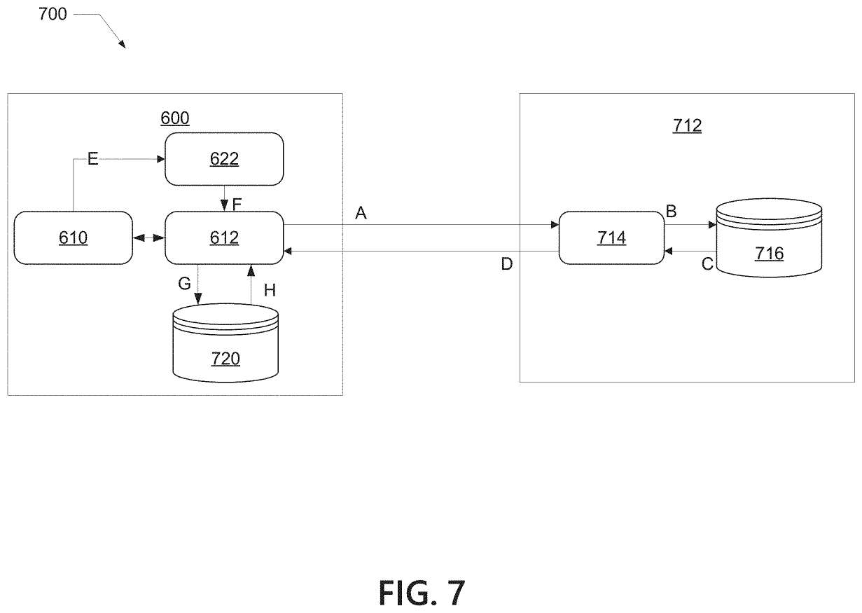

FIG. 7 depicts an example system flow 700 illustrating interactions between the mobile device 600 and a server 712. The server 712 may include a processor 111 as described with reference to FIG. 1 or processor 203 described with reference to FIG. 2 controlling overall operation of the server 712. The server may include memory 113, 115, and 120 described with reference to FIG. 1 or memory 215. The IME 612 may communicate with the server 712 via a controller 714. The controller 714 may query a database 716 based on one or more communications from the IME 612 of the mobile device 600.

In some examples, a user of the mobile device 600 may utilize the interface 610 to input data into an input field, such as a username or password field, of a known application. Other such data may be input such as an answer to a security question, a personal identification number, a date of birth, a social security number, or a bank account number. Certain input fields that may correspond to highly sensitive user input such as a password, a social security number, or an answer to a security question may be referred to as sensitive input fields. In some examples, whether certain input fields may be considered as sensitive user input fields is application specific. For example, a username field might not be considered a sensitive user input field in a social media application, whereas a username field in a financial institution application may be considered a sensitive user input field.

When the user selects input field 604 and the input field 604 receives an input focus 606 (e.g., input field 604 is selected for user input and a cursor appears signifying data entry may begin), the IME 612 may send the input method type (e.g. an indication of the type of input field) of the input field 604 to the controller 714 of the server 712 (identified by arrow “A” in FIG. 7). The input method type may be based on the iOS or Android Input Method framework. The controller 714 of the server 712 may receive the input method type and may query the database 716 (identified by arrow “B” in FIG. 7), which may store one or more mappings, assignments or other associations between input field control properties and known applications. The database 716 may return, to the controller 714, the input field type of the input field types based on the application in which input field 604 has input focus 606 (identified by arrow “C” in FIG. 7). The controller 714 may compare the input method type of the input field 604 with the input method type of the input field. If the input method type of the input field 604 matches the input method type of the input field, the controller 714 may send an indication to the IME 612 that may cause the IME 612 to adjust at least one characteristic of the mobile device 600 indicative of the operation of the mobile device (identified by arrow “D” in FIG. 7). Such mobile device characteristics may include vibration motor operation, microphone operation, speaker operation, or motion sensor operation. For example, the IME 612 may disable and enable the operation of the motion sensors. The motion sensors may measure motion data generated by user interaction with the soft alphanumeric keyboard 608. The raw motion data may comprise the rate of rotation around the x-, y- and z-axes of the mobile device measured by a gyroscopic sensor, the force of gravity along the x-, y-, and z-axes of the mobile device measured by a gravity sensor, the rotation vector component along the x-, y-, and z-axes of the mobile device measured by a rotation vector sensor, the geomagnetic field strength along the x-, y-, and z-axes of the mobile device measured by a magnetometer, the azimuth, pitch, and roll of the mobile device measured by an orientation sensor, or the acceleration force along the x-, y- and z-axes of the mobile device measured by an accelerometer.

In some examples, the IME 612 may enable, for example, a vibration motor component to emit vibrations which may alter or obscure the output generated by the gyroscopic sensor, accelerometer, and/or magnetometer responsive to user tapping on the soft keyboard 608. The vibration motor may emit a constant vibration with either low-intensity, high-intensity, or variable intensity output, or may emit a number of vibrations having variable duration, rhythm, and/or intensity (i.e. having a random pattern). In another example, the IME 612 may mute audio output from the mobile device 600 in combination with enabling the vibration motor component.

In some examples, the IME 612 may disable at least one of the motion sensors installed on the mobile device 600 after the user input field 604 receives input focus 606. In one example, this may occur after a soft keyboard 608 populates the user interface but prior to user input 604a into the soft keyboard 608. The IME 612 may disable the motion sensors in addition to muting the audio output from the mobile device 600. The user of the mobile device 600 may then select input field 605, which may cause input field 604 to lose input focus. Based on the selection, the interface 610 may send the input method type of the input field 605 to the controller 714 of the server 712 (identified by arrow “A” in FIG. 7) and repeat the additional steps as identified by arrows “B-D” in FIG. 7.

In some examples, the IME 612 may locally facilitate the steps as identified by arrows “E-H” in FIG. 7 by communicating with the interface 610, the API 622, and a local database 720. When the user selects input field 604 and the input field 604 receives an input focus 606 (identified by arrow “E” in FIG. 7), the IME 612 may inspect the input method type of the input field 604. In some examples, the API 622 of the mobile device 600 may indicate the input method type. The IME 612 may receive the input method type indication from the API 622 (identified by arrow “F” in FIG. 7) and may query the local database 720 (identified by arrow “G” in FIG. 7), which may store one or more mappings, assignments or other associations between input field control properties and known applications. The local database 720 may return, to the IME 612, the input method type of the input field type based on the application in which input field 604 has input focus 606 (identified by arrow “H” in FIG. 7). The IME 612 may compare the input method type of the input field 604 with the input method type of the input field. If the input method type of the input field 604 matches the input method type of the input field, the IME 612 may adjust at least one characteristic of the mobile device 600 indicative of the operation of the mobile device as described above.

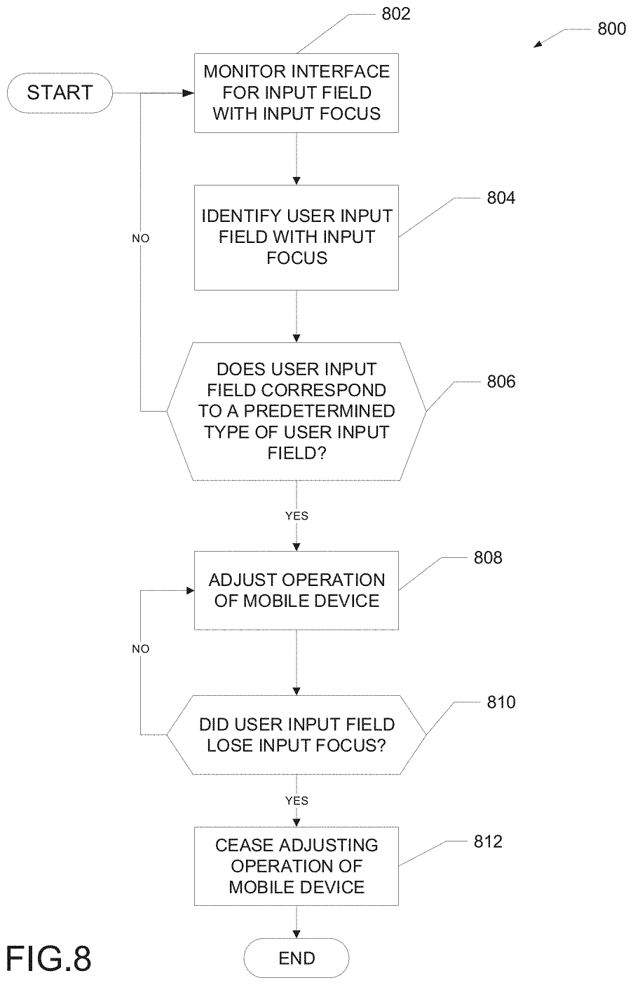

FIGS. 8-10 depict illustrative flow diagrams of techniques that may cause adjustment of at least one characteristic of the mobile device indicative of the operation of the mobile device. In one embodiment, the techniques 800-1000 may be a software application executable by the IME 612 on the mobile device 600. During installation of the technique 800 onto the mobile device 600, a user may be prompted to enable certain permissions to allow the IME 612 to intercept and monitor the user interface 610 and/or to control (e.g. disable and enable) the motion sensors installed on the mobile device 600.

The technique 800 may begin with the IME 612 monitoring the user interface 610 for an input field 604 that has received input focus 606 (802). The user interface 610 may include a first user input field 604 and second user input field 605 of a native application installed on the mobile device 600. It will be appreciated that the user interface 610 may include any number of input fields. The first input field 604 may correspond to a username input field and the second user input field 605 may correspond to a password input field. After a user taps or selects an input field 604 and the input field 604 receives input focus 606 (e.g., the selected input field may receive user input 604a entered from the keyboard 608), the IME 612 may inspect the input method type of the input field 604. In one example, the IME 612 may monitor the user interface 610 via the mobile device's remote debugging protocol to intercept and inspect the display 602 of the mobile device 600 to determine that an input field 604 corresponds to a particular type of input field. For example, the display 602 of the mobile device 600 may indicate that the text input 604a is being obscured or concealed and therefore corresponds to a protected input field. After the IME 612 intercepts the image of the display, it may determine that the input field 604 corresponds, for example, to a password input field. In some examples, the API 622 of the mobile device 600 may identify the particular type of input field and communicate that indication to the IME 612. The IME 612 may send the indicated input method type of the input field 604 to the controller 714 (804). The controller 714 may access the database 716 to obtain a look-up table mapping input fields to known applications. For example, table 1 below illustrates example input fields that may be mapped to example applications:

TABLE 1

| Input Field(s) | Known Applications |
|---|---|
| Password, Answer to Security | Social media applications |
| Question(s) | (Facebook, Instagram, Twitter, |
| | etc.) |
| Password, Username, Social | Mobile Banking Applications or |
| Security Number, Account | other financial institution |
| Number, Date of Birth | applications |
| Username and Password | Microsoft Outlook, Gmail, and |
| | other e-mail applications |

The controller 714 may compare the input method type of user input field 604 to the input method types of the input fields based on the type of native application (806). If the controller 714 determines that the input field 604 does not correspond to a type of input field, (806: NO), the controller 714 may send an indication to the IME 612 to continue monitoring the input method type of the input field.

If the controller 714 determines that the input field 604 corresponds to a type of input field, (806: YES), the IME 612 may adjust at least one characteristic of the mobile device indicative of the operation of the mobile device (808) according to the methods described with respect to FIG. 7. The IME 612 may disable any combination of the motion sensors, in addition to causing vibrations and/or muting the audio output from the mobile device 600.

In some examples, the duration of step 808 may occur during a period in which the user input field 604 has input focus 606. At step 810, the IME 612 may determine whether the user input field 604 has lost input focus 606 (e.g., input field 604 is deselected) by examining whether there has been a change in the input method type of the input field, whether input field 605 has been selected, or whether the soft keyboard 608 no longer populates the user interface 610. If the user input field 604 has not lost input focus 606, or the soft keyboard continues to populate the user interface 610 (810: NO), the IME 612 may continue to adjust operation of the mobile device 600 (808). If the user input field 604 has lost input focus 606, or the soft keyboard no longer populates the user interface 610 (810: YES), the IME 612 may cease adjusting the operation of the mobile device 600 (812). In another example, the IME 612 may cease adjusting the operation of the mobile device 600 based on the user input 604a no longer corresponding to the user input field 604. In another example, the IME 612 may cease adjusting the operation of the mobile device 600 based on the user input field 604 no longer corresponding to a type of user input field. The technique 800 may execute any number of times.

In some examples, the IME 612 may locally facilitate steps 802-812 by communicating with the interface 610, the API 622, and the local database 720. The IME 612 may monitor the user interface 610 for an input field 604 that has received input focus 606 (802). After a user taps or selects an input field 604 and the input field 604 receives input focus 606, the IME 612 may inspect the input method type of the input field 604 according to the methods described above (804). In some examples, the IME 612 may access the local database 720 to obtain a look-up table mapping input fields to known applications. The IME 612 may compare the input method type of user input field 604 to the input method types of the input fields based on the type of native application (806). If the IME 612 determines that the input field 604 does not correspond to a type of input field, (806: NO), the IME 612 may continue to monitor the user interface for an input field with input focus (802). If the IME 612 determines that the input field 604 does correspond to a type of input field, (806: YES), the IME 612 may adjust at least one characteristic of the mobile device indicative of the operation of the mobile device (808) according to the methods described with respect to FIG. 7. The IME 612 may disable any combination of the motion sensors, in addition to causing vibrations and/or muting the audio output from the mobile device 600. At step 810, the IME 612 may determine whether the user input field 604 has lost input focus 606 (e.g., input field 604 is deselected) by examining whether there has been a change in the input method type of the input field, whether input field 605 has been selected, or whether the soft keyboard 608 no longer populates the user interface 610. If the user input field 604 has not lost input focus 606, or the soft keyboard continues to populate the user interface 610 (810: NO), the IME 612 may continue to adjust operation of the mobile device 600 (808). If the user input field 604 has lost input focus 606, or the soft keyboard no longer populates the user interface 610 (810: YES), the IME 612 may cease adjusting operation of the mobile device 600 (812).

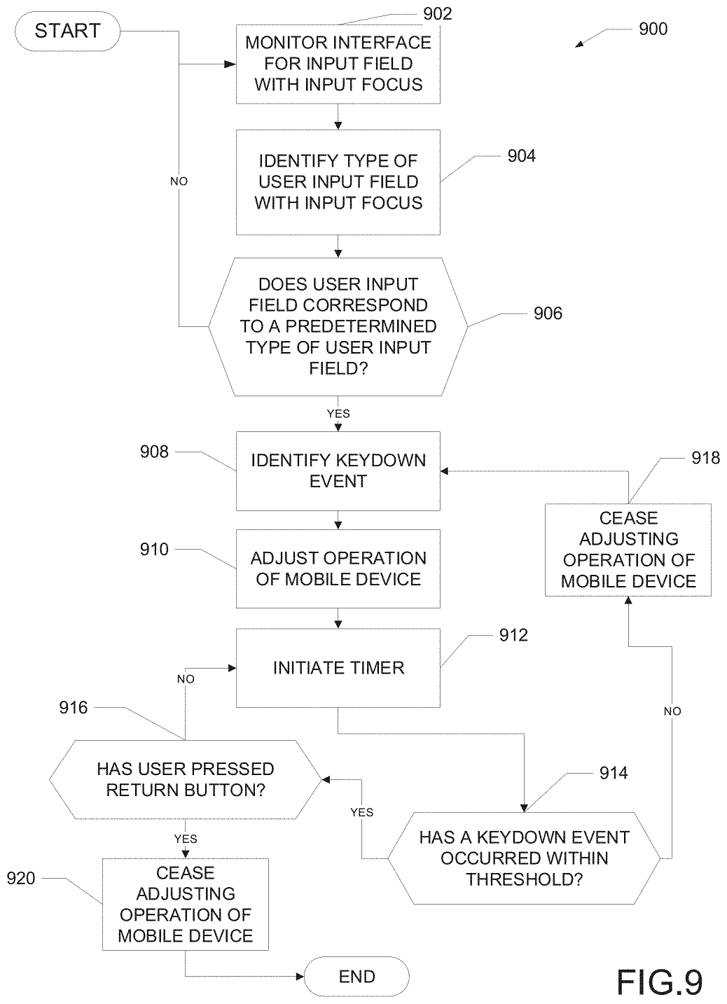

FIG. 9 depicts another illustrative flow diagram of a technique 900 that may cause the mobile device 600 to adjust, for example, at least one characteristic of the mobile device indicative of the operation of the mobile device after receipt of a touch input within the input field. Technique 900 is similar in many respects to the technique 800 described above with reference to FIG. 8 and may include features not mentioned above. Technique 900 may begin with the IME 612 monitoring the user interface 610 for an input field 604 that has input focus 606 (902). After receipt of a touch input within the input field 604, the IME 612 may identify the type of user input field that has input focus 606 (904) according to the methods described with reference to FIGS. 7-8. The IME 612 may determine whether the input field 604 corresponds to a type of user input field according to the methods described with reference to FIGS. 7-8 (906). If the input field 604 corresponds to a type of user input field, the IME 612 may identify when the keyboard 608 receives a “keydown” event (e.g. an indication that a key has been pressed on the keyboard 608) that may correspond to user input 604a. The keydown event may identify that a user presses a key on the keyboard 608. The keydown indication may describe a single interaction between the user and a key on keyboard 608, or a combination of a key with modifier keys (e.g., shift, tab, etc.). The keydown event may be represented as a code sent from the API 622 to the IME 612 indicating which specific key is pressed.

After the IME 612 has received an indication that a user has pressed a key on the keyboard 608 (908), the IME 612 may adjust the operation of the mobile device according to the foregoing methods discussed with reference to FIG. 7 (910). In some examples, the IME 612 may adjust operation of the mobile device 600 by disabling the motion sensors. The IME 612 may disable any combination of the motion sensors, in addition to causing vibrations and/or muting the audio output from the mobile device 600. The IME 612 may initiate a timer to measure the time elapsed after different keydown events (912). If another keydown event does not occur before the timer reaches a threshold (i.e. 10 seconds) (914: NO), the IME 612 may cease adjusting operation of the mobile device until another keydown event is identified (918). If another keydown event does occur before the timer reaches the pre-determined threshold (914: YES), the IME 612 may determine if the keydown event corresponds to a return button (916). If the IME 612 determines that a user presses the “return” or “enter” key to signal the mobile device to input the user input 604a (916: YES), the IME 612 may cease adjusting the operation of the mobile device. If the IME 612 determines that a user presses any other key besides “return” or “enter” key (916: NO), the timer may be reinitialized or otherwise reset (912). The IME 612 may disable any combination of the motion sensors, in addition to causing vibrations and/or muting the audio output from the mobile device 600. The technique 900 may execute any number of times. In one example, the technique 900 may omit steps 904-906 and proceed from step 902 to step 908.

After the IME 612 determines that a user has pressed a key on the keyboard 608 (i.e. a keydown event has occurred) (908), the IME 612 may adjust the operation of the mobile device according to the foregoing methods discussed with reference to FIG. 7 (910). The IME 612 may initiate a timer to measure the time elapsed after each keydown event (912). If another keydown event does not occur before the timer reaches a threshold (i.e. 10 seconds) (914: NO), the IME 612 may cease adjusting the operation of the mobile device until another keydown event is identified (918). If another keydown event does occur before the timer reaches the threshold (1006: YES), the IME 612 may determine if the keydown event corresponds to a return button (916). If the IME 612 determines that a user presses the “return” or “enter” key to signal the mobile device to input the user input 604a (916: YES), the technique 900 may end and the IME 612 may cease adjusting operation of the mobile device (920). If the IME 612 determines that a user presses any other key besides “return” or “enter” key (916: NO), the timer may be reinitialized or reset (912). The IME 612 may disable any combination of the motion sensors, in addition to causing vibrations and/or muting the audio output from the mobile device 600. The technique 900 may execute any number of times.

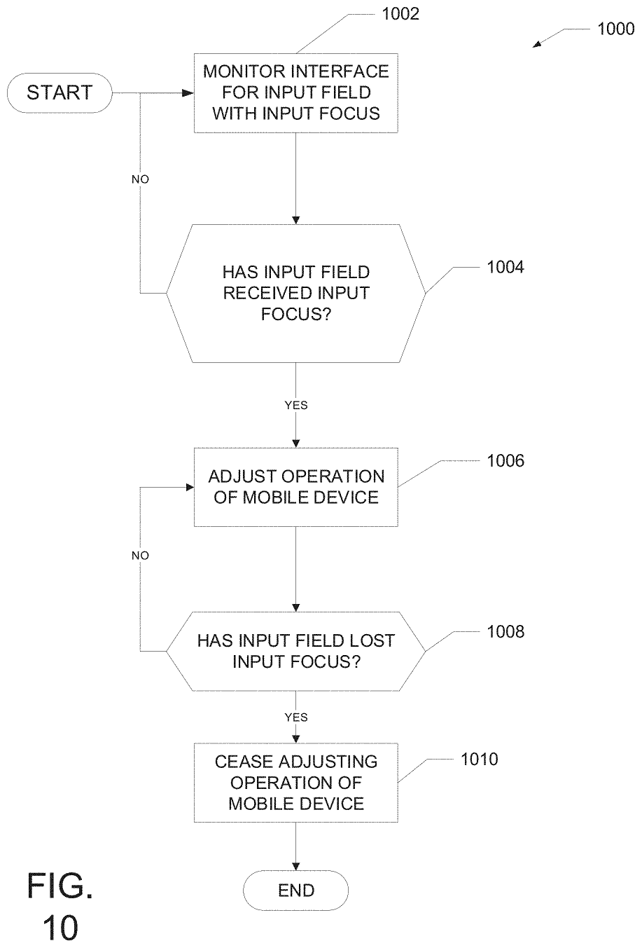

FIG. 10 depicts another illustrative flow diagram of a technique 1000 that may cause the IME 612 to adjust, for example, at least one characteristic of the mobile device indicative of the operation of the mobile device after identification of an input field 604 with input focus 606. Technique 1000 may begin with the IME 612 monitoring the user interface 610 for an input field 604 (1002) according to the methods as described in FIGS. 7-9. After a user taps or selects the input field 604, giving it an input focus 606 (1004: YES), the IME 612 may adjust the operation of the mobile device according to the methods described with reference to FIG. 7 (1006). The IME 612 may disable any combination of the motion sensors, in addition to causing vibrations and/or muting the audio output from the mobile device 600. The IME 612 may continue to adjust the operation of the mobile device 600 while the input field 604 has input focus 606 (1008: YES). In one example, if the input field 604 loses input focus 606, the IME 612 may cease adjusting the operation of the mobile device 600 (1010). In another example, if the input field 604 ceases to have input focus 606, IME 612 may begin monitoring the user interface 610 for an input field 604 with input focus 606 (1002). The technique 1000 may execute any number of times.

The following paragraphs (M1) through (M8) describe examples of methods that may be implemented in accordance with the present disclosure.

(M1) A method comprising monitoring a user interface presented on a display of a mobile device, wherein the user interface enables access to an application, and wherein the display receives touch input for entry of data into the application, identifying, based on content of the user interface, an input field of the application shown within the display, and adjusting operation of the mobile device in response to entry of data within the input field, the adjusting operation occurring via an input method, the input method changing at least one characteristic of the mobile device indicative of entry of data with use of the mobile device, so as to prevent acquisition of the data by a malicious application installed on the mobile device.

(M2) A method may be performed as described in paragraph (M1) further comprising determining whether the input field corresponds to a predetermined input field.

(M3) A method may be performed as described in any of paragraphs (M1) through (M2) wherein the input method comprises a virtual alphanumeric keyboard, and wherein the adjusting operation of the mobile device occurs after the keyboard receives a first keydown event.

(M4) A method may be performed as described in any of paragraphs (M1) through (M3) wherein the adjusting operation of the mobile device comprises disabling, in response to receipt of the touch input within the input field, the touch input occurring prior to the keyboard receiving a first keydown event, at least one of a gyroscopic sensor component, an accelerometer component, orientation sensor component, gravity sensor component, rotation vector sensor component, or a magnetometer component of the mobile device, and enabling, after a specified amount of time has elapsed without receiving a keydown event at the keyboard, at least one of a gyroscopic sensor component, an accelerometer component, orientation sensor component, gravity sensor component, rotation vector sensor component, or a magnetometer component of the mobile device.

(M5) A method may be performed as described in any of paragraphs (M1) through (M4) wherein the adjusting operation of the mobile device comprises disabling, after the keyboard receives a first keydown event, at least one of a gyroscopic sensor component, an accelerometer component, orientation sensor component, gravity sensor component, rotation vector sensor component, or a magnetometer component of the mobile device, and enabling, after passage of a specified time without receiving a keydown event at the keyboard, at least one of a gyroscopic sensor component, an accelerometer component, orientation sensor component, gravity sensor component, rotation vector sensor component, or a magnetometer component of the mobile device.

(M6) A method may be performed as described in any of paragraphs (M1) through (M5) wherein the adjusting operation of the mobile device comprises disabling, after the keyboard receives a first keydown event, at least one of a gyroscopic sensor component, an accelerometer component, orientation sensor component, gravity sensor component, rotation vector sensor component, or a magnetometer component of the mobile device, and enabling, after the input field loses an input focus, at least one of a gyroscopic sensor component, an accelerometer component, orientation sensor component, gravity sensor component, rotation vector sensor component, or a magnetometer component of the mobile device.

(M7) A method may be performed as described in any of paragraphs (M1) through (M6) wherein the adjusting operation of the mobile device comprises activating, in response to receipt of a touch input within the input field, a vibration motor of the mobile device, and muting, in response to receipt of a touch input within the input field, audio output from the mobile device.

(M8) A method may be performed as described in any of paragraphs (M1) through (M7) wherein the input field is a password input field.

The following paragraphs (A1) through (A8) describe examples of apparatuses that may be implemented in accordance with the present disclosure.

(A1) An apparatus comprising one or more processors and a memory storing instructions that, when executed by the one or more processors, cause the apparatus to monitor a user interface presented on a display of a mobile device, wherein the user interface enables access to an application, and wherein the display receives touch input for entry of data into the application, identify, based on content of the user interface, an input field of the application shown within the display, and adjust operation of the mobile device via an input method in response to entry of data within the input field, the input method changing at least one characteristic of the mobile device indicative of entry of data with use of the mobile device, so as to prevent acquisition of the data by a malicious application installed on the mobile device.

(A2) An apparatus as described in paragraph (A1), wherein the instructions, when executed by the one or more processors, further cause the apparatus to determine whether the input field corresponds to a predetermined input field.

(A3) An apparatus as described in any of paragraphs (A1) through (A2), wherein the input method comprises a virtual alphanumeric keyboard, and wherein the adjusting operation of the mobile device occurs after the keyboard receives a first keydown event.

(A4) An apparatus as described in any of paragraphs (A1) through (A3), wherein the adjusting operation of the mobile device comprises disabling, in response to receipt of the touch input within the input field, at least one of a gyroscopic sensor component, an accelerometer component, orientation sensor component, gravity sensor component, rotation vector sensor component, or a magnetometer component of the mobile device, and enabling, after a specified amount of time has elapsed without receiving a keydown event at the keyboard, at least one of a gyroscopic sensor component, an accelerometer component, orientation sensor component, gravity sensor component, rotation vector sensor component, or a magnetometer component of the mobile device.

(A5) An apparatus as described in any of paragraphs (A1) through (A4), wherein the adjusting operation of the mobile device comprises disabling, after the keyboard receives a first keydown event, at least one of a gyroscopic sensor component, an accelerometer component, orientation sensor component, gravity sensor component, rotation vector sensor component, or a magnetometer component of the mobile device, and enabling, after passage of a specified time without receiving a keydown event at the keyboard, at least one of a gyroscopic sensor component, an accelerometer component, orientation sensor component, gravity sensor component, rotation vector sensor component, or a magnetometer component of the mobile device.

(A6) An apparatus as described in any of paragraphs (A1) through (A5), wherein the adjusting operation of the mobile device comprises disabling, after the keyboard receives a first keydown event, at least one of a gyroscopic sensor component, an accelerometer component, orientation sensor component, gravity sensor component, rotation vector sensor component, or a magnetometer component of the mobile device, and enabling, after the input field loses an input focus, at least one of a gyroscopic sensor component, an accelerometer component, orientation sensor component, gravity sensor component, rotation vector sensor component, or a magnetometer component of the mobile device.

(A7) An apparatus as described in any of paragraphs (A1) through (A6), wherein the adjusting operation of the mobile device comprises activating, in response to receipt of a touch input within the input field, a vibration motor of the mobile device, and muting, in response to receipt of a touch input within the input field, audio output from the mobile device.

(A8) An apparatus as described in any of paragraphs (A1) through (A7), wherein the input field is a password input field.

The following paragraphs (S1) through (S4) describe examples of systems that may be implemented in accordance with the present disclosure.

(S1) A system comprising a mobile device comprising one or more processors and a memory, wherein the memory stores instructions that, when executed by the one or more processors, cause the mobile device to monitor a user interface presented on a display of the mobile device, the user interface enabling access to an application, and the display configured to receive touch input for entry of data into the application, identify, based on content of the user interface, an input field of the application shown within the display, and adjust operation of the mobile device via an input method in response to entry of data within the input field, the input method configured to change at least one characteristic of the mobile device indicative of entry of data with use of the mobile device, so as to prevent acquisition of the data by a malicious application installed on the mobile device.

(S2) A system as described in paragraph (S1), wherein the instructions, when executed by the one or more processors, further cause the mobile device to disable, in response to receipt of the touch input within the input field, the touch input occurring prior to the keyboard receiving a first keydown event, at least one of a gyroscopic sensor component, an accelerometer component, orientation sensor component, gravity sensor component, rotation vector sensor component, or a magnetometer component of the mobile device, and enable, after a specified amount of time has elapsed without receiving a keydown event at the keyboard, at least one of a gyroscopic sensor component, an accelerometer component, orientation sensor component, gravity sensor component, rotation vector sensor component, or a magnetometer component of the mobile device.

(S3) A system as described in any of paragraphs (S1) through (S2), wherein the instructions, when executed by the one or more processors, further cause the mobile device to disable, after the keyboard receives a first keydown event, at least one of a gyroscopic sensor component, an accelerometer component, orientation sensor component, gravity sensor component, rotation vector sensor component, or a magnetometer component of the mobile device, and enable, after passage of a specified time without receiving a keydown event at the keyboard, at least one of a gyroscopic sensor component, an accelerometer component, orientation sensor component, gravity sensor component, rotation vector sensor component, or a magnetometer component of the mobile device.

(S4) A system as described in any of paragraphs (S1) through (S4), wherein the instructions, when executed by the one or more processors, further cause the mobile device to determine whether the input field corresponds to a predetermined input field.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

1. A method comprising:
monitoring a user interface presented on a display of a mobile device, wherein the user interface enables access to an application, and wherein the display receives touch input for entry of data into the application;
identifying, based on content of the user interface, an input field of the application shown within the display; and
adjusting operation of the mobile device in response to entry of data within the input field, the adjusting operation occurring via an input method, the input method changing at least one characteristic of the mobile device indicative of entry of data with use of the mobile device, so as to prevent acquisition of the data by a malicious application installed on the mobile device.

2. The method of claim 1, further comprising determining whether the input field corresponds to a predetermined input field.

3. The method of claim 1, wherein the input method comprises a virtual alphanumeric keyboard, and wherein the adjusting operation of the mobile device occurs after the keyboard receives a first keydown event.

4. The method of claim 1, wherein the adjusting operation of the mobile device comprises:
disabling, in response to receipt of the touch input within the input field, the touch input occurring prior to the keyboard receiving a first keydown event, at least one of a gyroscopic sensor component, an accelerometer component, orientation sensor component, gravity sensor component, rotation vector sensor component, or a magnetometer component of the mobile device; and
enabling, after a specified amount of time has elapsed without receiving a keydown event at the keyboard, at least one of a gyroscopic sensor component, an accelerometer component, orientation sensor component, gravity sensor component, rotation vector sensor component, or a magnetometer component of the mobile device.

5. The method of claim 1, wherein the adjusting operation of the mobile device comprises:
disabling, after the keyboard receives a first keydown event, at least one of a gyroscopic sensor component, an accelerometer component, orientation sensor component, gravity sensor component, rotation vector sensor component, or a magnetometer component of the mobile device; and
enabling, after passage of a specified time without receiving a keydown event at the keyboard, at least one of a gyroscopic sensor component, an accelerometer component, orientation sensor component, gravity sensor component, rotation vector sensor component, or a magnetometer component of the mobile device.

6. The method of claim 1, wherein the adjusting operation of the mobile device comprises:
disabling, after the keyboard receives a first keydown event, at least one of a gyroscopic sensor component, an accelerometer component, orientation sensor component, gravity sensor component, rotation vector sensor component, or a magnetometer component of the mobile device; and
enabling, after the input field loses an input focus, at least one of a gyroscopic sensor component, an accelerometer component, orientation sensor component, gravity sensor component, rotation vector sensor component, or a magnetometer component of the mobile device.

7. The method of claim 1, wherein the adjusting operation of the mobile device comprises:
activating, in response to receipt of a touch input within the input field, a vibration motor of the mobile device; and
muting, in response to receipt of a touch input within the input field, audio output from the mobile device.

8. The method of claim 1, wherein the input field is a password input field.

9. An apparatus comprising:
one or more processors; and
memory storing instructions that, when executed by the one or more processors, cause the apparatus to:
monitor a user interface presented on a display of a mobile device, wherein the user interface enables access to an application, and wherein the display receives touch input for entry of data into the application;
identify, based on content of the user interface, an input field of the application shown within the display; and
adjust operation of the mobile device via an input method in response to entry of data within the input field, the input method changing at least one characteristic of the mobile device indicative of entry of data with use of the mobile device, so as to prevent acquisition of the data by a malicious application installed on the mobile device.

10. The apparatus of claim 9, wherein the instructions, when executed by the one or more processors, further cause the apparatus to determine whether the input field corresponds to a predetermined input field.

11. The apparatus of claim 9, wherein the input method comprises a virtual alphanumeric keyboard, and wherein the adjusting operation of the mobile device occurs after the keyboard receives a first keydown event.

12. The apparatus of claim 9, wherein the adjusting operation of the mobile device comprises:
disabling, in response to receipt of the touch input within the input field, at least one of a gyroscopic sensor component, an accelerometer component, orientation sensor component, gravity sensor component, rotation vector sensor component, or a magnetometer component of the mobile device; and
enabling, after a specified amount of time has elapsed without receiving a keydown event at the keyboard, at least one of a gyroscopic sensor component, an accelerometer component, orientation sensor component, gravity sensor component, rotation vector sensor component, or a magnetometer component of the mobile device.

13. The apparatus of claim 9, wherein the adjusting operation of the mobile device comprises:
disabling, after the keyboard receives a first keydown event, at least one of a gyroscopic sensor component, an accelerometer component, orientation sensor component, gravity sensor component, rotation vector sensor component, or a magnetometer component of the mobile device; and
enabling, after passage of a specified time without receiving a keydown event at the keyboard, at least one of a gyroscopic sensor component, an accelerometer component, orientation sensor component, gravity sensor component, rotation vector sensor component, or a magnetometer component of the mobile device.

14. The apparatus of claim 9, wherein the adjusting operation of the mobile device comprises:
disabling, after the keyboard receives a first keydown event, at least one of a gyroscopic sensor component, an accelerometer component, orientation sensor component, gravity sensor component, rotation vector sensor component, or a magnetometer component of the mobile device; and
enabling, after the input field loses an input focus, at least one of a gyroscopic sensor component, an accelerometer component, orientation sensor component, gravity sensor component, rotation vector sensor component, or a magnetometer component of the mobile device.

15. The apparatus of claim 9, wherein the adjusting operation of the mobile device comprises:
activating, in response to receipt of a touch input within the input field, a vibration motor of the mobile device; and
muting, in response to receipt of a touch input within the input field, audio output from the mobile device.

16. The apparatus of claim 9, wherein the input field is a password input field.

17. A system comprising:
A mobile device comprising one or more processors and a memory;
wherein the memory stores instructions that, when executed by the one or more processors, cause the mobile device to:
monitor a user interface presented on a display of the mobile device, the user interface enabling access to an application, and the display configured to receive touch input for entry of data into the application;
identify, based on content of the user interface, an input field of the application shown within the display; and
adjust operation of the mobile device via an input method in response to entry of data within the input field, the input method configured to change at least one characteristic of the mobile device indicative of entry of data with use of the mobile device, so as to prevent acquisition of the data by a malicious application installed on the mobile device.

18. The system of claim 17, wherein:
the instructions, when executed by the one or more processors, further cause the mobile device to:
disable, in response to receipt of the touch input within the input field, the touch input occurring prior to the keyboard receiving a first keydown event, at least one of a gyroscopic sensor component, an accelerometer component, orientation sensor component, gravity sensor component, rotation vector sensor component, or a magnetometer component of the mobile device; and
enable, after a specified amount of time has elapsed without receiving a keydown event at the keyboard, at least one of a gyroscopic sensor component, an accelerometer component, orientation sensor component, gravity sensor component, rotation vector sensor component, or a magnetometer component of the mobile device.

19. The system of claim 17, wherein the instructions, when executed by the one or more processors, further cause the mobile device to:
disable, after the keyboard receives a first keydown event, at least one of a gyroscopic sensor component, an accelerometer component, orientation sensor component, gravity sensor component, rotation vector sensor component, or a magnetometer component of the mobile device; and
enable, after passage of a specified time without receiving a keydown event at the keyboard, at least one of a gyroscopic sensor component, an accelerometer component, orientation sensor component, gravity sensor component, rotation vector sensor component, or a magnetometer component of the mobile device.

20. The system of claim 17, wherein the instructions, when executed by the one or more processors, further cause the mobile device to determine whether the input field corresponds to a predetermined input field.
